(19) United States
(12) Patent Application Publication
(10) Pub. No.: US 2020/0185967 A1
(43) Pub. Date: Jun. 11, 2020

(54) POWER FEED DEVICE

(71) Applicant: TOSHIBA TEC KABUSHIKI KAISHA, Tokyo (JP)

(72) Inventors: Takuya OGISHIMA, Izu Shizuoka (JP); Masakazu KATO, Numazu Shizuoka (JP)

(21) Appl. No.: 16/569,056

(22) Filed: Sep. 12, 2019

(30) Foreign Application Priority Data
Dec. 5, 2018 (JP) 2018-227923

(51) Int. Cl. H02J 50/12; H02J 7/02; H02J 50/40; H01F 38/14; H02J 50/90

(52) U.S. Cl. CPC H02J 50/12; H02J 7/025; H02J 50/80; H01F 38/14; H02J 50/90; H02J 50/40

(57) ABSTRACT

A power feed device includes a plurality of coils, a transmission circuit, and a control circuit. The plurality of coils is arranged offset from each other in a direction along a surface on which a chargeable device is to be placed. The transmission circuit is configured to supply an alternating current to the plurality of coils. The control circuit is configured to control the transmission circuit to supply an alternating current to the plurality of coils for a predetermined period of time, and control the transmission circuit to supply an alternating current selectively to the one or more of the plurality of coils for the power supplying for which the detected current exceeded a threshold value.

### CROSS-REFERENCE TO RELATED APPLICATION

This application is based upon and claims the benefit of priority from Japanese Patent Application No. 2018-227923, filed Dec. 5, 2018, the entire contents of which are incorporated herein by reference.

### FIELD

Embodiments of the present disclosure relate generally to a power supplying device which supplies electric power by electromagnetic coupling.

### BACKGROUND

There is in current practical use a power supplying system that supplies electric power from a power feed device by electromagnetic coupling. The power feed device includes a transmission coil that supplies power to a power reception device that includes a power reception coil by electromagnetic coupling. In such a system, the power feed system supplies the electric power from the power feed device to the power reception device while the power feed device and the power reception device are not directly connected by a wire or cord, but rather merely electromagnetically coupled to one another.

It is possible to increase an area to which power is feedable (“feedable range”) by making the transmission coil larger in a planar dimension. However, the coupling coefficient between the transmission coil and the power reception coil decreases in accordance with the difference in areas of the transmission coil and the power reception coil. When the coupling coefficient is small because there is a large difference in area between the transmission coil and the power reception coil, sufficient power may not be fed in an efficient manner. To address this issue, there are power feed devices that include different transmission coils and can be adjusted to supply power to the power reception device using one or more of the available transmission coils.

In general, the magnetic flux density generated by the transmission coil decreases with an increase in the distance from the center of the coil wiring. Therefore, when the power reception device is placed so that the transmission coil and the power reception coil are not fully overlapped with each other, power may not be supplied from the power feed device to the power reception device in an efficient manner.

### DESCRIPTION OF THE DRAWINGS

FIG. 1 is a diagram illustrating a configuration example of a power feed system according to an embodiment.

FIG. 2 is a schematic block diagram illustrating a configuration example of a power feed device according to an embodiment.

FIG. 3 is a diagram illustrating a configuration example of a transmission coil.

FIG. 4 is a diagram illustrating a configuration example of another transmission coil.

FIG. 5 is a diagram illustrating a configuration example of still another transmission coil.

FIG. 6 is a diagram illustrating a configuration example of a transmission coil.

FIG. 7 is a schematic block diagram illustrating a configuration example of a power reception device.

FIG. 8 is a flowchart illustrating an example of an operation of the power reception device.

FIG. 9 is a flowchart illustrating an example of the operation of the power feed device.

FIG. 10 is a diagram illustrating another configuration example of a transmission coil.

### DETAILED DESCRIPTION

Example embodiments provide a power feed device having a wide feedable range.

In general, according to an embodiment, a power feed device includes a plurality of coils parallel to a surface on which a chargeable device can be placed. The coils are offset from each other in a direction parallel to the surface. A transmission circuit is configured to supply an alternating current to each coil in the plurality of coils. A control circuit is configured to control the transmission circuit to supply an alternating current to each coil in the plurality of coils over a predetermined period of time and detect a current flowing in each coil during the predetermined period of time. The control circuit controls the transmission circuit to supply an alternating current selectively to any coil in the plurality of coils for which a detected value of the current flowing in the coil during the predetermined period of time exceeds a threshold value.

Hereinafter, a power feed device according to one or more example embodiments will be described with reference to the drawings.

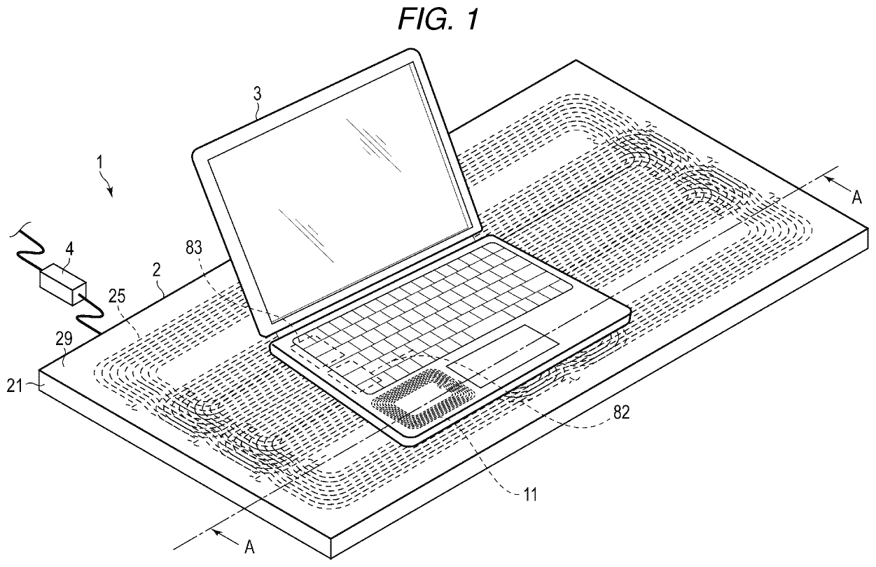

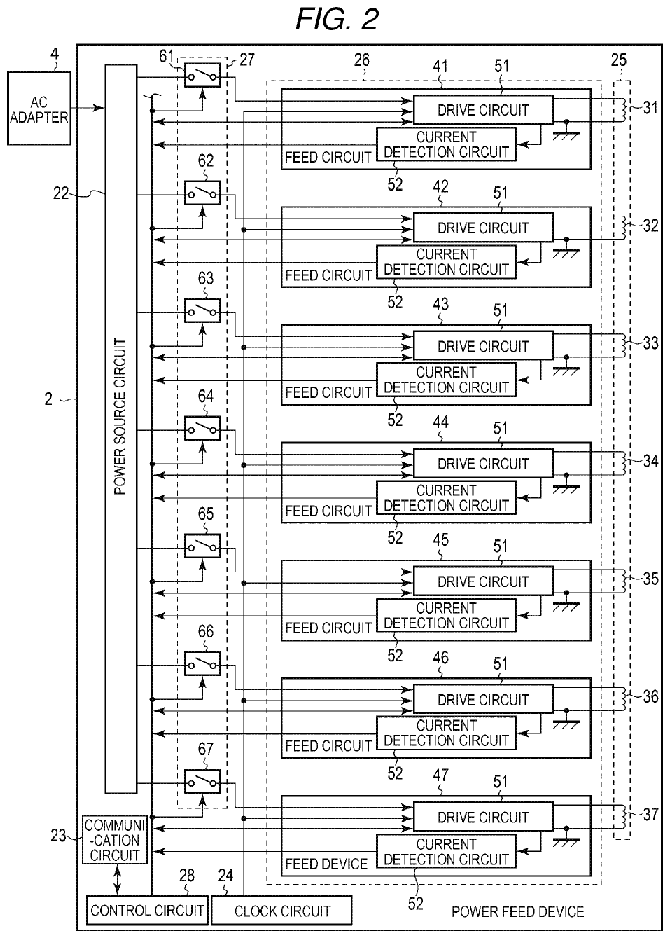

FIG. 1 is a diagram illustrating a configuration example of the power feed system 1. FIG. 2 is a schematic block diagram illustrating a configuration example of a power feed device 2.

The power feed system 1 includes the power feed device 2 that supplies (feeds) electric power and a power reception device 3 that receives the electric power from the power feed device 2.

The power feed device 2 supplies the electric power to the power reception device 3 using electromagnetic coupling such as electromagnetic induction or magnetic field resonance. That is, the power feed device 2 supplies the electric power to the power reception device 3 though is not directly connected to the power reception device 3 by a wire or cord. The power is transferred in a non-contact or wireless manner. A direct current electric power is supplied to the power feed device 2 from a commercial power source (e.g., an electric utility) through a direct current power source such as an AC adapter 4 or the like. The power feed device 2 converts the direct current electric power into alternating current electric power by power inversion, and supplies the alternating current electric power to the transmission coil to generate magnetic flux from the transmission coil.

The power reception device 3 receives the electric power supplied from the power feed device 2 using electromagnetic coupling such as magnetic induction or magnetic resonance. The power reception device 3 includes a power reception coil 11 that can be electromagnetically coupled to the transmission coil. The power reception device 3 receives the power for driving the power reception device 3 by rectifying and smoothing the power generated in the power reception coil 11 according to the change of the magnetic flux generated by the transmission coil. Non-limiting examples of a power reception device 3 include a portable information terminal such as a smartphone, a laptop PC, or a tablet PC. In addition, the power reception device 3 may be connected to a terminal of a portable information terminal such as the smartphone or the tablet PC specifically to supply the electric power supplied from the power feed device 2 to the portable information terminal.

As shown in FIGS. 1 and 2, the power feed device 2 includes a housing 21, a power source circuit 22, a communication circuit 23, a clock circuit 24, a transmission coil group 25, a transmission circuit group 26, a switch group 27, and a control circuit 28.

The housing 21 is a container, box, or chassis that accommodates the power source circuit 22, the communication circuit 23, the clock circuit 24, the transmission coil group 25, the transmission circuit group 26, the switch group 27, and the control circuit 28. In addition, a portion of the housing 21 is configured as a feed stand 29 on which the power reception device 3 is placed. The feed stand 29 is a portion of the housing 21 that is formed in a flat plate shape, and, in some examples, may serve as a tabletop, desktop, countertop, or the like.

The power source circuit 22 converts the voltage from an external direct current power source, such as the AC adapter 4, into a voltage suitable for operations of the various circuits of the power feed device 2. Thus, the power source circuit 22 generates the electric power (direct current voltage) for each transmission circuit of the transmission circuit group 26 and supplies this electric power to each transmission circuit. Further, the power source circuit 22 generates the electric power (a direct current voltage) for operating the control circuit 28, the clock circuit 24, and the communication circuit 23, and supplies this electric power to the control circuit 28, the clock circuit 24 and the communication circuit 23.

The communication circuit 23 in this example is an interface for wireless communication to/from the power reception device 3. The communication circuit 23 performs wireless communication at a frequency different from the frequency of power transmission. Examples of the communication circuit 23 include a wireless LAN circuit/card using a 2.4 GHz or 5 GHz band, a near field communication device using a 920 MHz band, a communication device using infrared rays, or the like. Specifically, in this particular example, the communication circuit 23 performs wireless communication in accordance with a standard such as Bluetooth® or Wi-Fi® protocols. In some examples, communication circuit 23 may include or incorporate a circuit that performs a signal processing to perform load modulation on a carrier wave of power transmission for communication with the power reception device 3.

The clock circuit 24 is a circuit that generates a signal (clock signal) indicating the timing of switching on and off a semiconductor switch incorporated in each transmission circuit of the transmission circuit group 26. That is, the clock circuit 24 generates a clock at the frequency of power transmission or the like. The clock circuit 24 supplies the generated clock signal to each transmission circuit of the transmission circuit group 26.

For example, when using an electromagnetic induction method for the power transmission, the clock circuit 24 generates a clock signal of about 100 kHz to 200 kHz. For example, the clock circuit 24 generates a clock signal in a MHz band such as 6.78 MHz or 13.56 MHz. Note that the frequency of the clock signal is not limited to the above, and may be changed according to the specifications of the power feed device 2 and the power reception device 3.

The transmission coil group 25 includes a first transmission coil 31, a second transmission coil 32, a third transmission coil 33, a fourth transmission coil 34, a fifth transmission coil 35, a sixth transmission coil 36, and a seventh transmission coil 37. The first transmission coil 31, the second transmission coil 32, the third transmission coil 33, the fourth transmission coil 34, the fifth transmission coil 35, the sixth transmission coil 36, and the seventh transmission coil 37 have substantially the same configuration, and accordingly, the first transmission coil 31 will be described as a representative example of each. The arrangement of each of these transmission coils will be described below.

The first transmission coil 31 generates a magnetic flux when a current flows therein. The first transmission coil 31 generates a periodically changing magnetic flux when an alternating current flows therein. The first transmission coil 31 is configured by arranging a conductive wire in parallel with a surface of the feed stand 29 of the housing 21. For example, the first transmission coil 31 is formed on a printed circuit board disposed parallel to the upper surface of the feed stand 29 of the housing 21. In other examples, the first transmission coil 31 may be fabricated as a stranded wire formed in a planar shape. The first transmission coil 31 forms a resonant circuit by being connected in series with a resonant capacitor, for example. Note that the resonant capacitor is not essential in all examples and may be omitted in some examples.

The transmission circuit group 26 includes a first transmission circuit 41, a second transmission circuit 42, a third transmission circuit 43, a fourth transmission circuit 44, a fifth transmission circuit 45, a sixth transmission circuit 46, and a seventh transmission circuit 47. The first transmission coil 31 is connected to the first transmission circuit 41. The second transmission coil 32 is connected to the second transmission circuit 42. The third transmission coil 33 is connected to the third transmission circuit 43. The fourth transmission coil 34 is connected to the fourth transmission circuit 44. The fifth transmission coil 35 is connected to the fifth transmission circuit 45. The sixth transmission coil 36 is connected to the sixth transmission circuit 46. The seventh transmission coil 37 is connected to the seventh transmission circuit 47. The first transmission circuit 41, the second transmission circuit 42, the third transmission circuit 43, the fourth transmission circuit 44, the fifth transmission circuit 45, the sixth transmission circuit 46, and the seventh transmission circuit 47 have the same configuration, and accordingly, the first transmission circuit 41 will be described as an example.

The first transmission circuit 41 causes an alternating current to flow through the first transmission coil 31 using the direct current electric power supplied from the power source circuit 22. The first transmission circuit 41 includes a drive circuit 51 that performs switching (inverting) based on the control of the control circuit 28 to cause an alternating current to flow through the first transmission coil 31 using the direct current electric power supplied from the power source circuit 22. The drive circuit 51 controls on and off states of the semiconductor switch based on a control signal supplied from the control circuit 28 and a clock signal supplied from the clock circuit 24 to convert the direct current electric power supplied from the power source circuit 22 into an alternating current. In addition, the first transmission circuit 41 also includes a current detection circuit 52 that detects a level of the current (current value) flowing through the first transmission coil 31 and outputs the detected current value to the control circuit 28.

The switch group 27 includes a first switch 61, a second switch 62, a third switch 63, a fourth switch 64, a fifth switch 65, a sixth switch 66, and a seventh switch 67. The first switch 61 is connected between the power source circuit 22 and the first transmission circuit 41. The second switch 62 is connected between the power source circuit 22 and the second transmission circuit 42. The third switch 63 is connected between the power source circuit 22 and the third transmission circuit 43. The fourth switch 64 is connected between the power source circuit 22 and the fourth transmission circuit 44. The fifth switch 65 is connected between the power source circuit 22 and the fifth transmission circuit 45. The sixth switch 66 is connected between the power source circuit 22 and the sixth transmission circuit 46. The seventh switch 67 is connected between the power source circuit 22 and the seventh transmission circuit 47. The first switch 61, the second switch 62, the third switch 63, the fourth switch 64, the fifth switch 65, the sixth switch 66, and the seventh switch 67 have the same configuration, and accordingly, the first switch 61 will be described as an example.

The first switch 61 switches the connection between the power source circuit 22 and the first transmission circuit 41 based on the control of the control circuit 28. That is, the first switch 61 switches between a state in which the power source circuit 22 and the first transmission circuit 41 are connected to each other and a state in which the power source circuit 22 and the first transmission circuit 41 are not connected to each other, based on the control of the control circuit 28. The first switch 61 may be provided in the first transmission circuit 41.

The control circuit 28 includes a processor and a memory. The processor is an arithmetic element that executes arithmetic processes. The processor performs various processes based on a program stored in a memory and the data used by the program, for example. The memory stores the program and the data used in the program. The control circuit 28 may be a microcomputer, a microprocessor, a microcontroller, or the like. The control circuit 28 may incorporate or provide the clock circuit 24 and thus may be configured to supply a clock signal to each transmission circuit.

The control circuit 28 controls operations of the switch group 27 and the transmission circuit group 26, respectively. In addition, the control circuit 28 controls the clock circuit 24 to adjust or set the frequency of the clock signal. Further, the control circuit 28 communicates with the power reception device 3 through the communication circuit 23.

The control circuit 28 switches the transmission coil(s) used for supplying by controlling the on and off states of each switch of the switch group 27. The control circuit 28 controls on and off states of each switch of the switch group 27 in accordance with the transmission coil to be used for supplying the power reception device 3. That is, the control circuit 28 controls the on and off states of each switch of the switch group 27 so that the direct current electric power is supplied from the power source circuit 22 to the transmission circuit that causes a current to flow through the transmission coils used for supplying the power reception device 3.

For example, when the first transmission coil 31 is used for supplying the power reception device 3, the control circuit 28 turns on the first switch 61 and turns off the second to seventh switches 62 to 67. As a result, the first transmission circuit 41 that causes a current to flow through the first transmission coil 31 is connected to the power source circuit 22.

Further, for example, when the first transmission coil 31 and the fifth transmission coil 35 are both used for supplying the power reception device 3, the control circuit 28 turns on the first and fifth switches 61 and 65, and turns off the second to fourth switches 62 to 64 and the sixth and seventh switches 66 and 67. As a result, the first transmission circuit 41 that causes a current to flow through the first transmission coil 31 is connected to the power source circuit 22, and the fifth transmission circuit 45 that causes a current to flow through the fifth transmission coil 35 is connected to the power source circuit 22.

Next, the arrangement of the transmission coils of the transmission coil group 25 of the power feed device 2 will be described.

The plurality of transmission coils is classified into different groups depending on the positions at which they are disposed. In this example, the first transmission coil 31, the second transmission coil 32, the third transmission coil 33, and the fourth transmission coil 34 are collectively referred to as a first transmission coil array 71. The fifth transmission coil 35 and the sixth transmission coil 36 are collectively referred to as a second transmission coil array 72. The seventh transmission coil 37 is referred to as a third transmission coil array 73. Note that the number and grouping of the transmission coils are not limited to this example, and may be appropriately changed according to the actual shape of the feed stand 29 and the expected or known shape of the power reception coil 11 of the power reception device 3.

As described above, each of the first transmission coil 31, the second transmission coil 32, the third transmission coil 33, the fourth transmission coil 34, the fifth transmission coil 35, the sixth transmission coil 36, and the seventh transmission coil 37 is configured to be the same size. The first transmission coil 31, the second transmission coil 32, the third transmission coil 33, the fourth transmission coil 34, the fifth transmission coil 35, the sixth transmission coil 36, and the seventh transmission coil 37 each have a long dimension and a short dimension, respectively. For example, in the long dimension, the coil is formed with a length twice as large as that in the short dimension.

An area within the wire positioned on the outermost periphery of the wire forming the coil of each of the first transmission coil 31, the second transmission coil 32, the third transmission coil 33, the fourth transmission coil 34, the fifth transmission coil 35, the sixth transmission coil 36, and the seventh transmission coil 37 will be referred to as the area of each coil. Each of the first transmission coil 31, the second transmission coil 32, the third transmission coil 33, the fourth transmission coil 34, the fifth transmission coil 35, the sixth transmission coil 36, and the seventh transmission coil 37 is formed to have an area larger than that of the power reception coil 11. Specifically, the ratio of the area of each of the first transmission coil 31, the second transmission coil 32, the third transmission coil 33, the fourth transmission coil 34, the fifth transmission coil 35, the sixth transmission coil 36, and the seventh transmission coil 37 to the power reception coil 11 is in the range of 1:(0.3) to 1:(0.4). That is, the area of the power reception coil 11 is 30 to 40% of the area of the first transmission coil 31, the area of the second transmission coil 32, and etc.

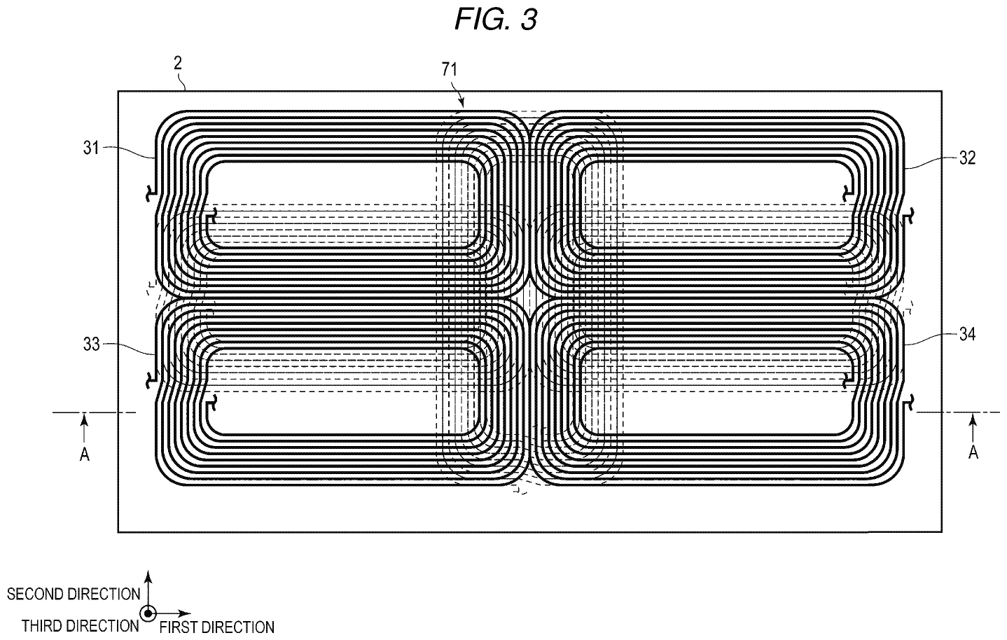

FIG. 3 is a diagram illustrating the arrangement of the transmission coils in the first transmission coil array 71.

The first transmission coil array 71 has a configuration in which at least two coil rows are arranged in a first direction parallel to the plane of the feed stand 29, and at least two coil rows are arranged in a second direction parallel to the plane of the feed stand 29 and orthogonal to the first direction. It is assumed that the first direction is a direction parallel to the long dimension of each transmission coil of the first transmission coil array 71, and the second direction is a direction parallel to the short dimension of each transmission coil of the first transmission coil array 71. That is, the coil rows of the first transmission coil array 71 are configured in an arrangement in which edges at the ends of the long dimension of the transmission coils, that is, the short sides of the transmission coils are adjacent to each other. Further, the coil rows are arranged such that edges at the ends of the short dimension of the transmission coils, that is, the long sides of the transmission coils are adjacent to each other. In other words, in this example the first transmission coil array 71 is configured by arraying four transmission coils in a 2×2 array.

More specifically, the first transmission coil 31 and the second transmission coil 32 are arranged such that the short side of the first transmission coil 31 and the short side of the second transmission coil 32 are adjacent to each other, thus forming one coil row. Further, the third transmission coil 33 and the fourth transmission coil 34 are arranged such that the short side of the third transmission coil 33 and the short side of the fourth transmission coil 34 are adjacent to each other, thus forming another coil row. The two coil rows are arranged such that the long side of the first transmission coil 31 and the long side of the third transmission coil 33 are adjacent to each other, and the long side of the second transmission coil 32 and the long side of the fourth transmission coil 34 are adjacent to each other, thus forming the first transmission coil array 71.

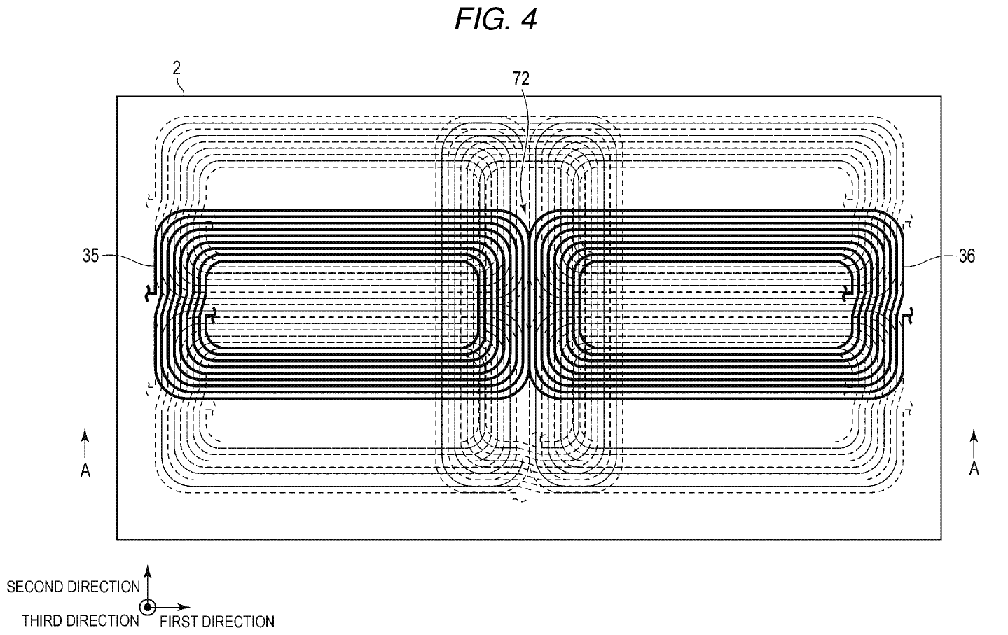

FIG. 4 is a diagram illustrating the arrangement of the transmission coils in the second transmission coil array 72.

The second transmission coil array 72 is configured of at least two coil rows arranged in the first direction. The coil rows of the second transmission coil array 72 are configured in an arrangement in which the edges in the long dimension of the transmission coil, that is, the short sides of the transmission coils are adjacent to each other.

More specifically, the fifth transmission coil 35 and the sixth transmission coil 36 are arranged such that the short side of the fifth transmission coil 35 and the short side of the sixth transmission coil 36 are adjacent to each other, thus forming the second transmission coil array 72.

The second transmission coil array 72 is arranged at a position overlapping, in a third direction orthogonal to the first direction and the second direction, with the edge of a transmission coil in the first transmission coil array 71. That is, in this example, the second transmission coil 72 is positioned above the first coil array 71 in a direction orthogonal to the plane of the feed stand 29. More particularly, in this example, the second transmission coil array 72 is disposed such an interior region of the coils of the second transmission coil array 72 overlap the positions where the long dimension edges of the different transmission coils of the first transmission coil array 71 face each other (see FIG. 4). More specifically, in this example, the interior region of the fifth transmission coil 35 is disposed at a position overlapping where a long side of the first transmission coil 31 and a long side of third transmission coil 33 face each other. In addition, the interior region of the sixth transmission coil 36 is similarly disposed at a position overlapping where the long sides of the second transmission coil 32 and the fourth transmission coil 34 face each other.

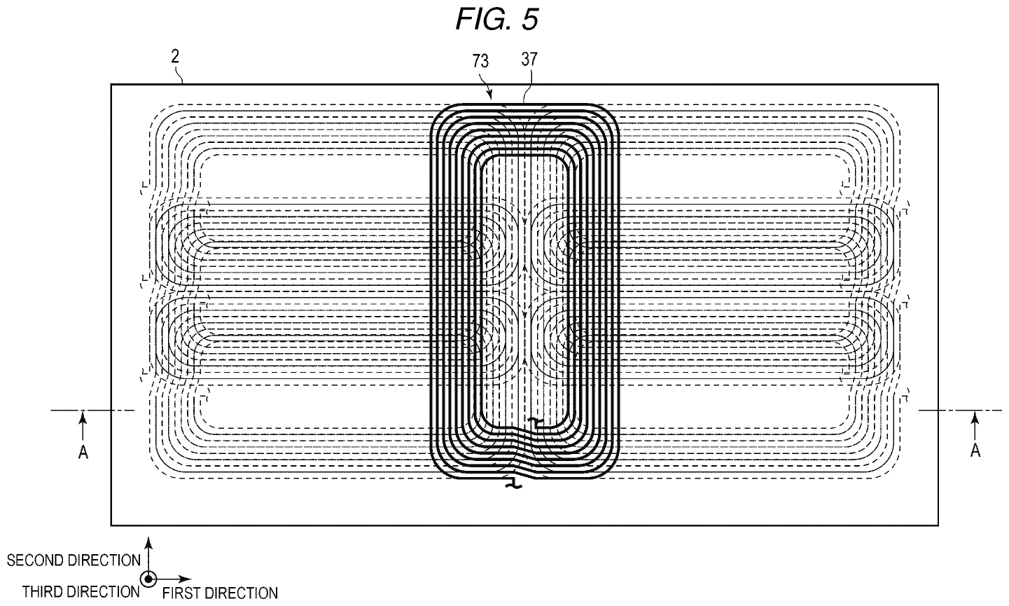

FIG. 5 is a diagram illustrating the arrangement of the transmission coils in the third transmission coil array 73.

The third transmission coil array 73 comprises a seventh transmission coil 37. The third transmission coil array 73 is arranged at a position in a third direction orthogonal to the first direction and the second direction overlapping with the inner short edges of the transmission coils of the second transmission coil array 72. That is, the third transmission coil array 73 is disposed such that the third transmission coil array 73 overlaps with the position where the short dimension edges of the transmission coils of the second transmission coil array 72 are adjacent to each other. More specifically, the seventh transmission coil 37 is disposed at a position where the short dimension sides of the fifth transmission coil 35 and the sixth transmission coil 36 are adjacent to each other. In addition, the seventh transmission coil 37 is disposed across a position where the short dimension sides of the first transmission coil 31 and the second transmission coil 32 of the first transmission coil array 71 are adjacent to each other and a position where the short dimension sides of the third transmission coil 33 and the fourth transmission coil 34 are adjacent to each other.

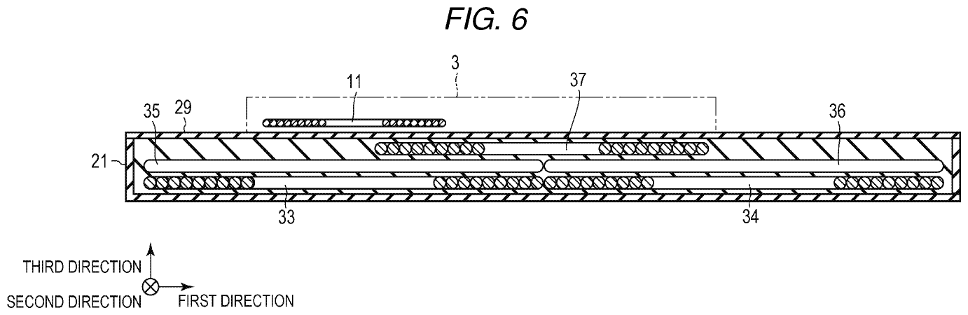

FIG. 6 illustrates a cross-sectional view of the power feed device 2 and the power reception coil 11 of the power reception device 3, taken along line AA of FIGS. 1 and 3-5.

The first transmission coil array 71 is disposed at a position farthest away from the feed stand 29 in the housing 21. The second transmission coil array 72 is disposed between the first transmission coil array 71 and the feed stand 29. The third transmission coil array 73 is disposed between the second transmission coil array 72 and the feed stand 29. That is, the first transmission coil array 71, the second transmission coil array 72, and the third transmission coil array 73, the transmission coils are overlapped with each other in the third direction in this order. However, in other examples, the stack ordering of the first transmission coil array 71, the second transmission coil array 72, and the third transmission coil array 73 in the third direction may be any order.

Next, the power reception device 3 will be described.

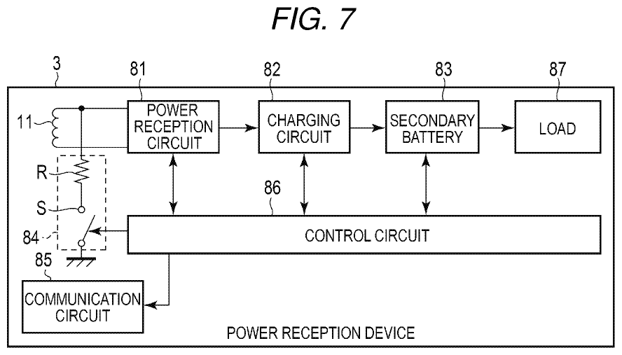

FIG. 7 is a schematic block diagram illustrating a configuration example of the power reception device 3. The power reception device 3 includes a power reception coil 11, a power reception circuit 81, a charging circuit 82, a secondary battery 83, a resistance circuit 84, a communication circuit 85, a control circuit 86, and a load 87.

The power reception coil 11 is an element that generates a current based on a change in magnetic flux. The power reception coil 11 is formed by arranging a conductive wire in parallel with a surface of the housing of the power reception device 3. For example, the power reception coil 11 is formed on a printed circuit board disposed in parallel with some surface of the power reception device 3. In other examples, the power reception coil 11 may comprise a stranded wire formed in a planar shape. The power reception coil 11 forms a resonant circuit by being connected in series or in parallel with a capacitor (not shown). When the power reception device 3 is placed on the feed stand 29 of the power feed device 2, the power reception coil 11 is electromagnetically coupled to transmission coil(s) of the transmission coil group 25 of the power feed device 2. The power reception coil 11 generates an induced current by the magnetic flux generated from the transmission coil of the power feed device 2. That is, a resonant circuit configured of the power reception coil 11 and a capacitor (not shown) serves as an alternating current power source that supplies alternating current electric power to the power reception circuit 81 connected to the resonant circuit.

For example, when the magnetic field resonance system is used for power transmission, a configuration is desirable, in which the self-resonant frequency of the resonant circuit including the power reception coil 11 is the same as, or substantially the same as the self-resonant frequency of the resonant circuit including the transmission coil of the power feed device 2. As a result, the transmission efficiency of the electric power when the transmission coil and the power reception coil are electromagnetically coupled is improved.

The power reception circuit 81 rectifies and converts the alternating current electric power generated in the power reception coil 11 into a direct current, and also makes the current smoother. The power reception circuit 81 includes a rectifier bridge including a plurality of diodes and a capacitor connected to an output terminal of the rectifier bridge, for example. A pair of input terminals of the rectifier bridge is connected to the power reception coil 11. The rectifier bridge performs full-wave rectification on the alternating current generated in the power reception coil 11 to output a direct current from the pair of output terminals. A capacitor of the power reception circuit 81 stores electric charge from the direct current output from the pair of output terminals of the rectifier bridge, and supplies direct current power to a circuit connected to a subsequent stage. As described above, the power reception circuit 81 supplies direct current electric power to the charging circuit 82.

The charging circuit 82 converts the direct current electric power supplied from the power reception circuit 81 into the direct current electric power (for example, constant current constant voltage charging) used for the charging process, and supplies the power to the secondary battery 83. As a result, the charging circuit 82 charges the secondary battery 83.

The secondary battery 83 is charged with the direct current electric power supplied from the charging circuit 82. In addition, the secondary battery 83 supplies the electric power to various components of the power reception device 3 such as the load 87, for example. For example, the secondary battery 83 is a lithium ion battery.

The resistance circuit 84 is a circuit including a resistor R which consumes the electric power received by the power reception coil 11. For example, the resistance circuit 84 includes the resistor R (resistance) and a switch S connected in series to the resistor R. The resistor R desirably has a resistance value that causes a change in a current in the transmission circuit of the power feed device 2. For example, the resistor R is a load resistance drawing about 0.3 W. The other terminal of the switch S is connected to GND. The switch S is controlled by the control circuit 86. The switch S connects the resistor R to GND when it is turned on.

The communication circuit 85 is an interface for performing wireless communication with the power feed device 2. The communication circuit 85 performs wireless communication at a frequency different from the frequency of power transmission. Examples of the communication circuit 85 include a wireless LAN using a 2.4 GHz or 5 GHz band, a near field communication device using a 920 MHz band, a communication device using infrared rays, and the like. Specifically, the communication circuit 85 performs wireless communication with the power feed device 2 in accordance with the standard such as Bluetooth® (or Wi-Fi®. The communication circuit 85 may also be used as the resistance circuit 84. In this case, the communication circuit 85 may perform a signal processing for performing load modulation on a carrier wave of power transmission for communication with the power feed device 2.

The control circuit 86 includes a processor and a memory. The processor is an arithmetic element that executes arithmetic processes. The processor performs various processes based on a program stored in a memory and the data used by the program, for example. The memory stores a program, the data used in the programs, and the like. The control circuit 86 may be configured of a microcomputer, microprocessor, microcontroller or the like.

The control circuit 86 controls operations of the power reception circuit 81, the charging circuit 82, the switch S of the resistance circuit 84, the communication circuit 85, and the like, respectively. The control circuit 86 controls the charging process of the secondary battery 83 by controlling the power reception circuit 81 and the charging circuit 82. In addition, the control circuit 86 controls the switch S of the resistance circuit 84 to switch between a state in which the power reception coil 11 is grounded through the resistor R and a state in which the power reception coil 11 is not grounded. Further, the control circuit 86 communicates with the power feed device 2 through the communication circuit 85.

Next, the operation of the power reception device 3 will be described.

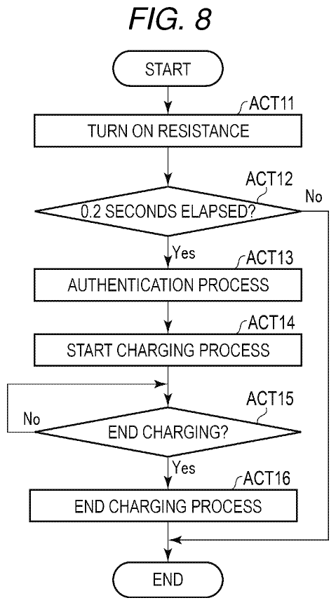

FIG. 8 is a flowchart illustrating an example of the operation of the power reception device 3.

The control circuit 86 of the power reception device 3 turns on the resistance (ACT11). The control circuit 86 determines whether or not the electric power is being received from the power feed device 2. When electric power is being received from the power feed device 2, the control circuit 86 turns on the switch S of the resistance circuit 84. As a result, the power reception coil 11 is connected to GND. For example, the control circuit 86 decides, whether or not the electric power is being received from the power feed device 2 using a current detector to detect a current flowing through the power reception coil 11.

The control circuit 86 determines whether 0.2 seconds has elapsed after turning on the resistance (ACT12). Note that the reference time for this determination is not limited to 0.2 seconds, and, in general, any time may be selected. The control circuit 86 determines whether or not the resistance is to be maintained in the ON state. When determining that the elapsed time has not yet reached 0.2 seconds after the resistance has been turned on, and that the resistance ON state is not be maintained (ACT12, NO), the control circuit 86 ends the process. The control circuit 86 may be configured to end the process when the supply of electric power from the power feed device 2 is at all interrupted after the turn-on of the resistance.

When the elapsed time since the resistance turn-on has reached 0.2 seconds and that the ON state is to be maintained (ACT12, YES), the control circuit 86 performs an authentication process by transmitting and receiving information to and from the power feed device 2 through the communication circuit 85 (ACT13). The authentication process is a process of determining whether or not the device that transmits the electric power to the power reception device 3 is a correct device. The power feed device 2 and the power reception device may jointly perform the authentication process by transmitting predetermined information to each other.

When the authentication process is completed, the control circuit 86 starts the charging process (ACT14). That is, the control circuit 86 turns off the switch S of the resistance circuit 84 and controls the power reception circuit 81 and the charging circuit 82 to charge the secondary battery 83 with the electric power generated in the power reception coil 11.

The control circuit 86 determines whether or not to end the charging process (ACT15). The control circuit 86 monitors the state of charge of the secondary battery 83, and determines whether the secondary battery 83 is sufficiently charged. When the secondary battery 83 is sufficiently charged, the control circuit 86 determines to end the charging process.

When the charging process is to be ended (ACT15, YES), the control circuit 86 ends the charging process (ACT16), and ends the process of FIG. 8.

Next, the operation of the power feed device 2 will be described.

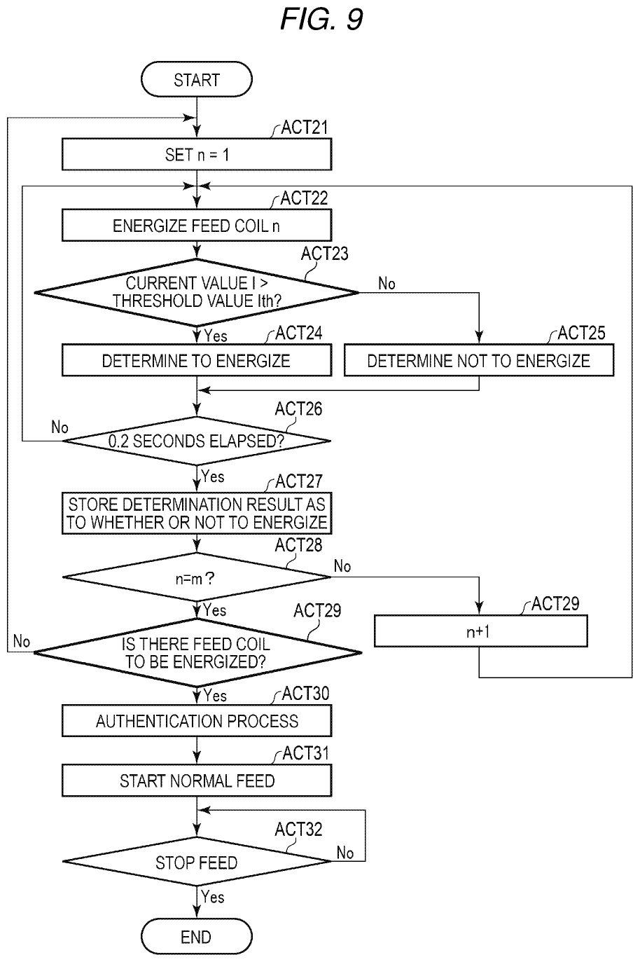

FIG. 9 is a flowchart illustrating an example of the operation of the power feed device 2.

In this example, the control circuit 28 of the power feed device 2 is in a standby state when then activated. The control circuit 28 executes the processes of FIG. 9 at a predetermined timing. For example, the control circuit 28 determines whether the power reception device 3 has been placed on the feed stand 29 by supplying an alternating current to each transmission coil of the transmission coil group 25 and detecting the current value. When determining that the power reception device 3 has been placed on the feed stand 29, the control circuit 28 executes the processes of FIG. 9.

The control circuit 28 first sets the value of the counter n to “1,” which is an initial value (ACT21). The control circuit 28 uses a predetermined storage area of the memory as the counter n, for example. That is, the control circuit 28 sets the value of the predetermined storage area of the memory to the initial value.

The control circuit 28 controls the switch group 27 and the transmission circuit group 26 such that an alternating current flows to the transmission coil that corresponds to the value of the counter n among the plurality of transmission coils of the transmission coil group 25 (ACT22). For example, when the value of the counter n is “1”, the control circuit 28 energizes the first transmission coil 31. When the value of the counter n is “2”, the control circuit 28 energizes the second transmission coil 32. The control circuit 28 acquires, from the current detection circuit 52, a current value while the alternating current is flowing to each transmission coil.

The control circuit 28 determines whether the current value I acquired from the current detection circuit 52 is greater than a preset (threshold) current Ith (ACT23). When it is determined that the current value I acquired from the current detection circuit 52 is greater than the preset current Ith (ACT23, YES), the control circuit 28 determines that the energized transmission coil will be used (energized) for supplying (ACT24). In addition, when determining that the current value I is equal to or less than the preset current Ith (ACT23, NO), the control circuit 28 determines that the energized transmission coil is not to be used (energized) for supplying (ACT25).

The control circuit 28 determines whether the elapsed time from the start of energization of the transmission coil has reached 0.2 seconds (ACT26). Note that the reference time for determination is not limited to 0.2 seconds, and any time may be set. That is, the control circuit 28 determines whether some predetermined time has elapsed since the start of energization. When the elapsed time from the start of energization has not yet reached 0.2 seconds (ACT26, NO), the control circuit 28 returns to the process of ACT 22.

Further, when the elapsed time from the start of energization reaches 0.2 seconds (ACT26, YES), the control circuit 28 stores the determination result as to whether or not to energize (ACT27). For example, the control circuit 28 stores the determination result as to whether or not to energize in ACT 24 and ACT 25 in a predetermined storage area of the memory.

The control circuit 28 determines whether the present value of the counter n is the preset value m (ACT28). When determining that the present value of the counter n is not the preset value m (ACT28, NO), the control circuit 28 increments (+1) the value of the counter n (ACT29), and proceeds to the process of ACT 22.

When the value of the counter n is the preset value m (ACT28, YES), the control circuit 28 determines whether any transmission coil is to be energized (ACT29). That is, the control circuit 28 determines, with reference to the memory, as to whether there is a transmission coil for which the determination result indicates that the coil is to be energized. When determining that there is no transmission coil that is to be energized (ACT29, NO), the control circuit 28 returns to process of ACT 21. As a result, the control circuit 28 resets the value of the counter n back to the initial value, and repeats the process of determining whether or not there is any transmission coil to be energized. Alternatively, when determining that there is no transmission coil to be energized (ACT29, NO), the control circuit 28 may end the process of FIG. 9 rather than repeating.

When the control circuit 28 determines that there is a transmission coil to be energized (ACT29, YES), the control circuit 28 performs authentication process by transmitting and receiving information to and from the power reception device 3 through the communication circuit 23 (ACT30).

When the authentication process is completed, the control circuit 28 starts normal feed (ACT31). A normal feed is a process of supplying the power reception device 3 using the transmission coil(s) for which the determination result indicates the coil is to be energized.

For example, as illustrated in FIG. 1, when the position of the power reception coil 11 of the power reception device 3 placed on the feed stand 29 is at a position overlapping with the third transmission coil 33 and the fifth transmission coil 35, it is detected that the current value when the alternating current flows to the third transmission coil 33 and the fifth transmission coil 35 is greater than the current value when the alternating current flows to the other transmission coils. For this reason, in the processes of ACT 22 to ACT 29, the third transmission coil 33 and the fifth transmission coil 35 are indicated as coils to be energized. That is, the control circuit 28 determines the transmission coils to be used for supplying the power reception device 3 based on the detected value of a current of when the alternating current is supplied to each specific transmission coil for a predetermined time. In this instance, when proceeding to the process of ACT 31, the control circuit 28 turns on the third switch 63 and the fifth switch 65 to operate the third transmission circuit 43 and the fifth transmission circuit 45 such that the third transmission coil 33 and the fifth transmission coil 35 are energized for supplying the power reception device 3. As a result, the control circuit 28 performs a feed to the power reception device 3 by causing an alternating current to flow through the third transmission coil 33 and the fifth transmission coil 35.

As described above, when a feed is performed by a plurality of transmission coils, the transmission circuit group 26 is controlled such that alternating currents flowing through the plurality of transmission coils have the same phase. That is, the control circuit 28 performs control such that the magnetic fluxes generated by the plurality of transmission coils do not cancel out each other by performing on and off control of the semiconductor switches of the plurality of transmission circuits at the same timing.

During the normal feed, the control circuit 28 determines whether or not to end the feed (ACT32). For example, when the power reception device 3 is removed from the feed stand 29 or when the power reception device 3 is fully charged, the control circuit 28 determines to end the feed. For example, the control circuit 28 determines whether the power reception device 3 has been removed from the feed stand 29 by monitoring changes in the value of the current flowing through the transmission coil. Furthermore, the control circuit 28 can determine that the secondary battery 83 of the power reception device 3 is fully charged by acquiring such information from the power reception device 3 through the communication circuit 23, and thus end the feed on this basis.

When determining that the feed is to be stopped (ACT32, YES), the control circuit 28 turns off all the switches of the switch group 27, stops the transmission circuit, and ends the processes of FIG. 9. When determining that the feed is not to be stopped (ACT32, NO), the control circuit 28 periodically performs the determination of ACT 32 while continuing the feed process.

As described above, the power feed device 2 includes the power source circuit 22, the transmission coil group 25, the transmission circuit group 26, the switch group 27, and the control circuit 28.

The transmission coil group 25 includes the first transmission coil array 71 including a plurality of transmission coils and the second transmission coil array 72 including a plurality of transmission coils. The plurality of transmission coils of the first transmission coil array 71 are two-dimensionally arranged. The plurality of transmission coils of the second transmission coil array 72 are disposed at positions overlapping the edges of the plurality of coils that make up the first transmission coil array 71. The power source circuit 22 outputs a direct current voltage. The transmission circuit group 26 is provided for each transmission coil of the transmission coil group 25, and separately supplies an alternating current to the transmission coils by the direct current voltage output from the power source circuit 22. The switch group 27 switches the connection state between the power source circuit 22 and each transmission circuit of the transmission circuit group 26. The control circuit 28 acquires the value of the current while switching the transmission coil through which the alternating current flows by the switch group 27. The control circuit 28 selects a transmission coil to be used for supplying based on the value of the current.

The control circuit 28 controls the switch group 27 and the transmission coil group 25 so that the alternating current flows to the selected transmission coil. As a result, the control circuit 28 performs a feed to the power reception device 3 by the selected transmission coil.

According to the above configuration, the transmission coils of the second transmission coil array 72 are disposed to overlap with the position (edge) where the magnetic flux density of the transmission coils of the first transmission coil array 71 is low. Therefore, the power feed device 2 may feed sufficient electric power regardless of the position where the power reception device 3 is placed on the feed stand 29. As a result, it is possible to provide a power feed device having a wide feedable range.

Further, the power feed device 2 applies an alternating current to the plurality of transmission coils individually for a short time, and selects a transmission coil to be used for supplying based on the value of the current at that time. Thus, the power feed device 2 may select a coil suitable for supplying without communicating with the power reception device 3.

Further, when a feed is performed by a plurality of transmission coils, the control circuit 28 of the power feed device 2 controls the transmission circuit group 26 so that alternating currents flowing through the plurality of transmission coils have the same phase. Thus, the power feed device 2 may prevent the magnetic fluxes generated by the plurality of transmission coils from canceling out each other.

Further, the plurality of transmission coils of the second transmission coil array 72 are disposed such that the edges of the plurality of coils that make up the first transmission coil array 71 overlap with each other at the adjacent positions. Thus, the power feed device 2 may compensate the region where the magnetic flux density generated by the transmission coils of the first transmission coil array 71 is low, by the magnetic flux generated by the transmission coils of the second transmission coil array 72.

In addition, the transmission coil group 25 further includes the third transmission coil array 73 including transmission coils disposed such that the edges of the plurality of transmission coils of the second transmission coil array 72 overlap with each other at the adjacent positions. Thus, the power feed device 2 may compensate the region where the magnetic flux density generated by the transmission coils of the second transmission coil array 72 is low, by the magnetic flux generated by the transmission coils of the third transmission coil array 73.

The plurality of transmission coils of the first transmission coil array 71 are respectively arranged in the first direction and the second direction parallel to the feed stand 29 on which the power reception device 3 is placed.

Further, the plurality of transmission coils of the second transmission coil array 72 are arranged in the first direction and the second direction. The plurality of transmission coils of the second transmission coil array 72 are arranged at a position where the edges of the transmission coil of the first transmission coil array 71 overlap with each other at the adjacent positions in the second direction.

In addition, the transmission coil of the third transmission coil array 73 is arranged at a position where the edges of the transmission coil of the second transmission coil array 72 overlap with each other at the adjacent positions in the first direction.

Each transmission coil is formed in the same shape, and has a long dimension and a short dimension. In addition, the transmission coils of the first transmission coil array 71 and the second transmission coil array 72 are arranged such that the long dimension coincides with the first direction and the short dimension coincides with the second direction. Further, the transmission coils of the third transmission coil array 73 are arranged such that the long dimension coincides with the second direction and the short dimension coincides with the first direction. Furthermore, the length of each transmission coil in the long dimension is formed to be twice the length in the short dimension. According to such a configuration, when the first transmission coil array 71 includes four transmission coils and the second transmission coil array 72 includes two transmission coils, the third transmission coil array 73 may be configured of one transmission coil.

As described above in the embodiment, the first transmission coil array 71 is configured by arranging a plurality of transmission coils adjacent to each other on long sides or short sides, but is not limited thereto. In the first transmission coil array 71, the long sides or the short sides of the plurality of transmission coils may be arranged at predetermined intervals.

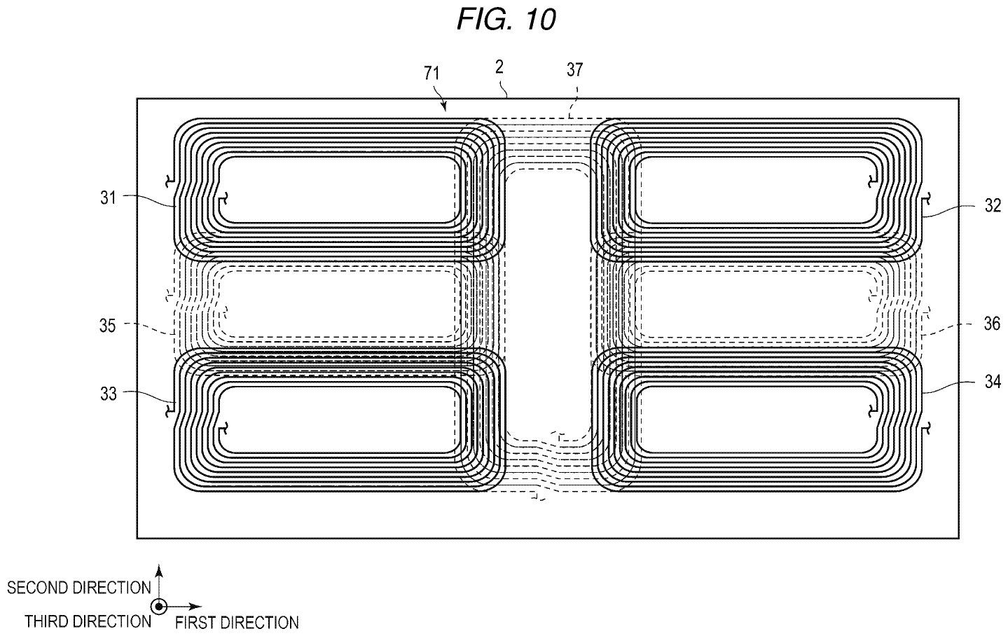

FIG. 10 shows an example in which a plurality of transmission coils are arranged at predetermined intervals in the first transmission coil array 71.

As shown in FIG. 10, in the first transmission coil array 71, the long sides of the plurality of transmission coils are arranged at predetermined intervals in the second direction. In this case, the transmission coils of the second transmission coil array 72 are provided to overlap with the long sides of the plurality of transmission coils of the first transmission coil array 71 aligned in at least in the second direction. Further, the transmission coils of the third transmission coil array 73 are provided to overlap with the short sides of the plurality of transmission coils of the first transmission coil array 71 and the second transmission coil array 72 aligned in at least in the first direction.

According to such a configuration, the power feed device 2 may provide a wider feedable region by the transmission coil group 25, without increasing the number of transmission coils of the transmission coil group 25.

Moreover, as described above in the embodiment, each transmission coil of the transmission coil group 25 has a long dimension and a short dimension, but is not limited to this structure. Each transmission coil of the transmission coil group 25 may have any shape such as a circle or a square.

As described above in the embodiment, the functions may be realized not only by using hardware but also by reading a program in which each function is described using software into a computer. In addition, each function may be configured by selecting either software or hardware as appropriate.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A power feed device, comprising:
a plurality of coils parallel to a surface on which a chargeable device can be placed, the coils being offset from each other in a direction parallel to the surface;
a transmission circuit configured to supply an alternating current to each coil in the plurality of coils; and
a control circuit configured to:
control the transmission circuit to supply an alternating current to each coil in the plurality of coils for a predetermined period of time and detect a current flowing in each coil during the predetermined period of time, and
control the transmission circuit to supply an alternating current selectively to a coil in the plurality of coils for which a detected value of the current flowing in the coil during the predetermined period of time exceeds a threshold value.

2. The power feed device according to claim 1, wherein a first coil of the plurality of coils partially overlaps with a second coil of the plurality of coils.

3. The power feed device according to claim 1, wherein the plurality of coils includes a first array of coils at a first distance from the surface and a second array of coils at a second distance from the surface, the second distance being less than the first.

4. The power feed device according to claim 3, wherein
the first array of coils includes coils with long dimension edges adjacent to each other, and
the second array of coils includes coils with long dimension edges adjacent to each other.

5. The power feed device according to claim 4, wherein a coil of the second array of coils overlaps the long dimension edges of at least two coils of the first array of coils.

6. The power feed device according to claim 3, wherein the plurality of coils includes a coil at a third distance from the surface, the third distance being less than the second distance.

7. The power feed device according to claim 1, wherein the control circuit is further configured to cause phases of alternating currents supplied to different coils in the plurality of coils to be different from one another.

8. The power feed device according to claim 1, wherein the control circuit is configured to control the transmission circuit to supply alternating current to each coil in the plurality of coils independently during the predetermined period of time.

9. The power feed device according to claim 1, wherein each coil in the plurality of coils has long dimension and a short dimension.

10. The power feed device according to claim 9, wherein each coil in the plurality of coils is on a printed circuit board.

11. A power supplying device, comprising:
a housing including a surface on which a chargeable device can be placed;
a plurality of coils in the housing and parallel to the surface, the coils being offset from each other in a direction parallel to the surface;
a transmission circuit configured to supply an alternating current to each coil in the plurality of coils; and
a control circuit configured to:
control the transmission circuit to supply an alternating current to each coil in the plurality of coils for a predetermined period of time and detect a current flowing in each coil during the predetermined period of time, and
control the transmission circuit to supply an alternating current selectively to a coil in the plurality of coils for which a detected value of the current flowing in the coil during the predetermined period of time exceeds a threshold value.

12. The power supplying device according to claim 11, wherein a first coil of the plurality of coils partially overlaps with a second coil of the plurality of coils.

13. The power supplying device according to claim 11, wherein the plurality of coils includes a first array of coils at a first distance from the surface and a second array of coils at a second distance from the surface, the second distance being less than the first.

14. The power supplying device according to claim 13, wherein
the first array of coils includes coils with long dimension edges adjacent to each other, and
the second array of coils includes coils with long dimension edges adjacent to each other.

15. The power supplying device according to claim 14, wherein a coil of the second array of coils overlaps the long dimension edges of at least two coils of the first array of coils.

16. The power supplying device according to claim 13, wherein the plurality of coils includes a coil at a third distance from the surface, the third distance being less than the second distance.

17. The power supplying device according to claim 11, wherein the control circuit is further configured to cause phases of alternating currents supplied to different coils in the plurality of coils to be different from one another.

18. The power supplying device according to claim 11, wherein the control circuit is configured to control the transmission circuit to supply alternating current to each coil in the plurality of coils independently during the predetermined period of time.

19. The power supplying device according to claim 11, wherein each coil in the plurality of coils has long dimension and a short dimension.

20. The power supplying device according to claim 19, wherein each coil in the plurality of coils is on a printed circuit board.
